(19) United States
(12) Patent Application Publication
(10) Pub. No.: US 2026/0250106 A1
(43) Pub. Date: Aug. 27, 2026

(54) HOIST MOUNTING ASSEMBLY

(71) Applicant: Wenger Corporation, Owatonna, MN (US)

(72) Inventors: Damon G. Atwood, Fishers, IN (US); Paul W. Zagajeski, Salina, NY (US); Jonathan F. Newell, Madison, WI (US)

(73) Assignee: Wenger Corporation, Owatonna, MN (US)

(21) Appl. No.: 19/544,309

(22) Filed: Feb. 19, 2026

Related U.S. Application Data
(60) Provisional application No. 63/764,063, filed on Feb. 27, 2025.

(51) Int. Cl. B66C 23/20

(52) U.S. Cl. CPC B66C 23/203

(57) ABSTRACT

A hoist mounting assembly comprises an elongate member, a clamp assembly, and a mounting bracket. The clamp assembly is operatively connected to the elongate member and is configured and arranged to selectively engage a portion of a building structure. The mounting bracket is operatively connected to the elongate member and is configured and arranged to selectively engage a hoist assembly.

### CROSS-REFERENCE TO RELATED APPLICATIONS

This application claims the benefit of U.S. Provisional Application Serial No. 63/764,063, filed February 27, 2025, which is incorporated herein by reference in its entirety.

### BACKGROUND

Performance venues such as theaters, concert halls, opera houses, arenas, and churches commonly use hoists to vertically raise and lower equipment including curtains, lighting, and scenery. Hoists assist in enhancing dramatic effects during performances and in masking equipment from view. They are also helpful for equipment maintenance. Examples of hoists and hoist systems include U.S. Patent Nos. 7,766,308 and 8,328,165 and U.S. Patent Application Publication 2023/0235793, the disclosures of which are incorporated herein by reference in their entireties.

Because equipment loads can be positioned or moved directly over performers, hoists used in performance venues have rigorous safety standards. As a result, two or more hoists working simultaneously can be used in a system (i.e., a rigging system) to meet the safety standards. Positioning the hoists in desired locations can be tedious, especially if two or more hoists are used.

For the reasons stated above and for other reasons stated below, which will become apparent to those skilled in the art upon reading and understanding the present specification, there is a need in the art for hoists that can be easily installed and selectively positioned.

### SUMMARY

The above-mentioned problems associated with prior devices are addressed by embodiments of the disclosure and will be understood by reading and understanding the present specification. The following summary is made by way of example and not by way of limitation. It is merely provided to aid in understanding some of the aspects of the invention.

In one embodiment, a hoist mounting assembly comprises an elongate member, a clamp assembly, and a mounting bracket. The clamp assembly is operatively connected to the elongate member and is configured and arranged to selectively engage a portion of a building structure. The mounting bracket is operatively connected to the elongate member and is configured and arranged to selectively engage a hoist assembly.

In one embodiment, a clamp assembly comprises an elongate member, a first side clamp, and a second side clamp. The first side clamp is operatively connected to the elongate member, and the first side clamp includes a first notch. The second side clamp is operatively connected to the elongate member, and the second side clamp includes a second notch. The first and second notches form a receiving channel configured and arranged to receive a portion of a building structure. The first and second side clamps are slidably operatively connected to the elongate member in a slidable clamp position and are secured to the elongate member in a secured clamp position.

In one embodiment, a mounting assembly comprises an elongate member, a mounting bracket, and a hoist connector. The mounting bracket is operatively connected to the elongate member. The mounting bracket is slidably operatively connected to the elongate member in a slidable mount position and is secured to the elongate member in a secured mount position. The hoist connector is configured and arranged to interconnect the mounting bracket and a hoist assembly.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

FIG. 1 is a perspective view of an embodiment hoist mounting assembly constructed in accordance with the principles of the present invention interconnecting a hoist assembly and a building structure;

FIG. 2 is a partially exploded perspective view of the hoist mounting assembly interconnecting the hoist and the building structure shown in FIG. 1;

FIG. 3 is a perspective view of a mounting bracket operatively connected to an elongate member of the hoist mounting assembly shown in FIG. 1;

FIG. 4 is an exploded perspective view of the hoist mounting assembly shown in FIG. 1;

FIG. 5 is an exploded perspective view of a beam clamp assembly of the hoist mounting assembly shown in FIG. 1;

FIG. 6 is an exploded perspective view of the beam clamp assembly shown in FIG. 5 and the mounting bracket shown in FIG. 3;

FIG. 7 is a partially exploded perspective view of the mounting bracket shown in FIG. 3 and a hoist assembly;

FIG. 8A illustrates a first configuration rigging assembly;

FIG. 8B illustrates a second configuration rigging assembly;

FIG. 8C illustrates a third configuration rigging assembly;

FIG. 8D illustrates a fourth configuration rigging assembly; and

FIG. 9 is a top view of the first configuration rigging assembly illustrated in FIG. 8A.

### DETAILED DESCRIPTION

In the following detailed description, reference is made to the accompanying drawings, which form a part hereof, and in which is shown by way of illustration embodiments in which the disclosure may be practiced. In this regard, directional terminology, such as "top," "bottom," "front," "back," "leading," "trailing," etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that other embodiments may be utilized and mechanical changes may be made without departing from the spirit and scope of the present disclosure. The following detailed description is, therefore, not to be taken in a limiting sense.

Embodiments of the disclosure generally provide a hoist mounting assembly, preferably for performance venues, including an elongate member providing a backbone structure and a mounting bracket to which a hoist assembly is operatively connected. The elongate member is operatively connected to a building structure and the mounting bracket enables the hoist assembly to be selectively positioned at any one of multiple locations along the elongate member. The mounting bracket can allow for the hoist assembly to be selectively slid along the elongate member in a slidable position, and the mounting bracket can selectively secure the hoist assembly in a desired position on the elongate member in a secured position. A plurality of elongate members can be used to mount a plurality of hoist assemblies in a staggered, parallel arrangement as part of a rigging assembly. A beam clamp assembly can be used to selectively position the elongate member to the building structure such as an I-beam or the like. The beam clamp assembly can allow for the elongate member to be selectively slid along the building structure in a slidable position, and the beam clamp assembly can selectively secure the elongate member in a desired position on the building structure in a secured position. The hoist mounting assembly also allows for mounting of hoist assemblies proximate catwalks and other structures.

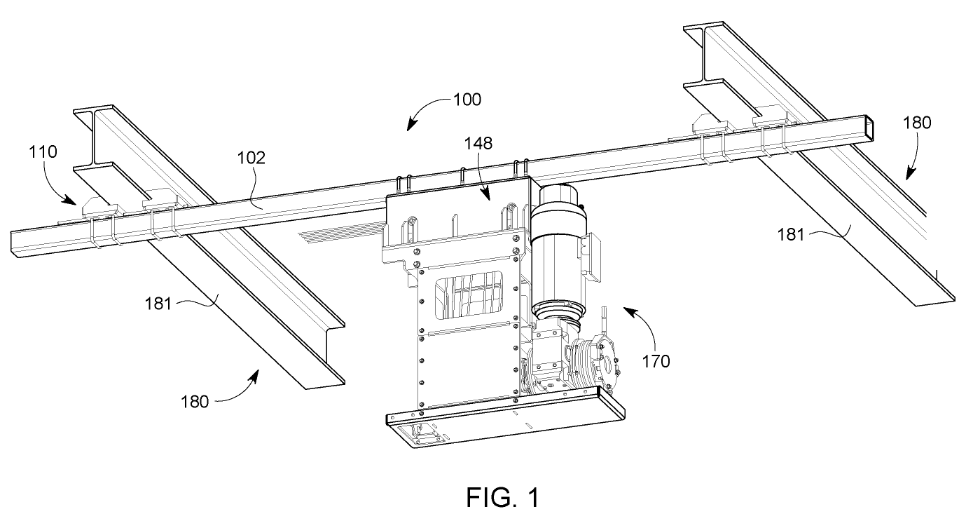

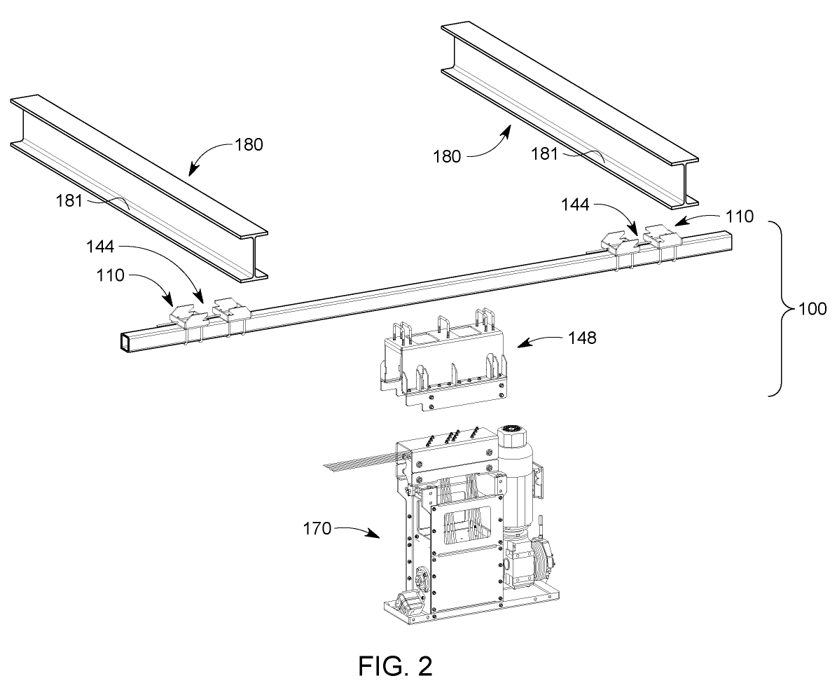

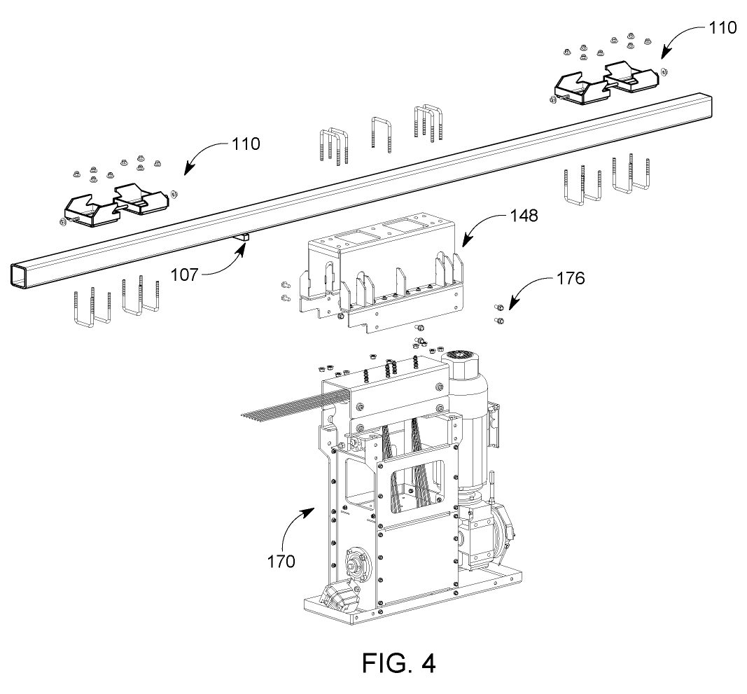

In an example embodiment, best illustrated in FIGS. 1, 2, and 4, a hoist mounting assembly 100 includes an elongate member 102, a beam clamp assembly 110, and a mounting bracket 148. The elongate member 102 provides a backbone structure to which the beam clamp assembly 110 and the mounting bracket 148 are operatively connected. Preferably, the beam clamp assembly 110 and the mounting bracket 148 are selectively positioned along the elongate member 102, for example by loosening the connections and sliding them into desired positions along the elongate member 102. In one example, the elongate member is preferably a rigid, square tube of a suitable diameter and a suitable length having first and second sides 105 and 106 interconnecting a top 103 and a bottom 106. An optional stop member 107, such as a block operatively connected to the elongate member 102, can be used if limiting travel along the elongate member 102 is desired. The elongate member 102 can be made of steel or any other suitable material for supporting the hoist mounting assembly 100 and the hoist assembly 170 and, if a stop member 107 is used, the stop member 107 can be soldered or welded onto the elongate member 102.

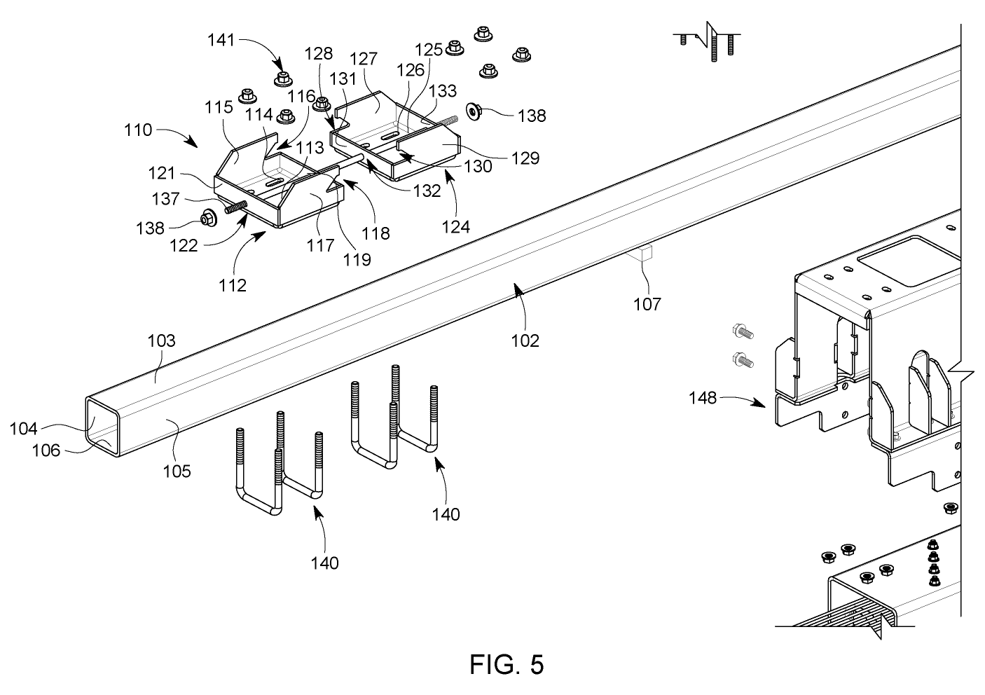

The beam clamp assembly 110 is configured and arranged to interconnect the elongate member 102 and a building structure such as an I-beam 180 including a flange 181. The building structure can be part of an existing building structure. The beam clamp assembly 110 is best illustrated in FIG. 5. A first side clamp 112 includes a base 113, which is preferably a rectangular plate, including slots 114 proximate opposing first and second sides 115 and 117. The first side 115 extends upward from a first edge of the base 113 and includes a first notch 116 proximate an inner edge of the base 113, and the second side 117 extends upward from an opposing second edge of the base 113 and includes a second notch 118 proximate the inner edge of the base 113. An inner end 119 extends upward from the inner edge of the base 113 between the first and second sides 115 and 117 and includes an aperture (not shown). An outer end 121 extends upward from the outer edge of the base 113 between the first and second sides 115 and 117 and includes an aperture 122 that aligns with the aperture in the inner end 119.

A second side clamp 124, which is similar to the first side clamp 112, includes a base 125, which is preferably a rectangular plate, including slots 126 proximate opposing first and second sides 127 and 129. The first side 127 extends upward from a first edge of the base 125 and includes a first notch 128 proximate an inner edge of the base 125, and the second side 129 extends upward from an opposing second edge of the base 125 and includes a second notch 130 proximate the inner edge of the base 125. An inner end 131 extends upward from the inner edge of the base 125 between the first and second sides 127 and 129 and includes an aperture 132. An outer end 133 extends upward from the outer edge of the base 125 between the first and second sides 127 and 129 and includes an aperture (not shown) that aligns with the aperture 132 in the inner end 131.

The notches 116 and 118 and the notches 128 and 130 form a receiving channel 144 configured and arranged to selectively receive a portion of the building structure, such as opposing sides of a flange 181 of an I-beam 180. A rod 136, preferably with threaded ends 137, is configured and arranged to extend through the apertures in the inner and outer ends of the first and second side clamps 112 and 124 and nuts 138 are operatively connected to the threaded ends 137 to secure the rod 136 to the first and second side clamps 112 and 124. The rod 136 and the nuts 138 can be used to selectively limit movement of the first and second side clamps 112 and 124 relative to one another, for example away from each other. Preferably, the rod 136 is positioned below the notches forming the receiving channel 144. With the flange 181 or other suitable structure positioned within the receiving channel 144, the nuts 138 are configured and arranged to secure the first and second side clamps 112 and 124 in a desired position relative to the flange 181 or other suitable structure. U-bolts 140 partially extend about the elongate member 102, for example about three sides, and through the slots 114 and 126, and nuts 141 secure the first and second side clamps 112 and 124 to the elongate member 102. The slots 114 and 126 allow the first and second side clamps 112 and 124 to move longitudinally relative to the elongate member 102 while still connected to the U-bolts 140 and the rod 136 when the nuts 138 and 141 are sufficiently loosened.

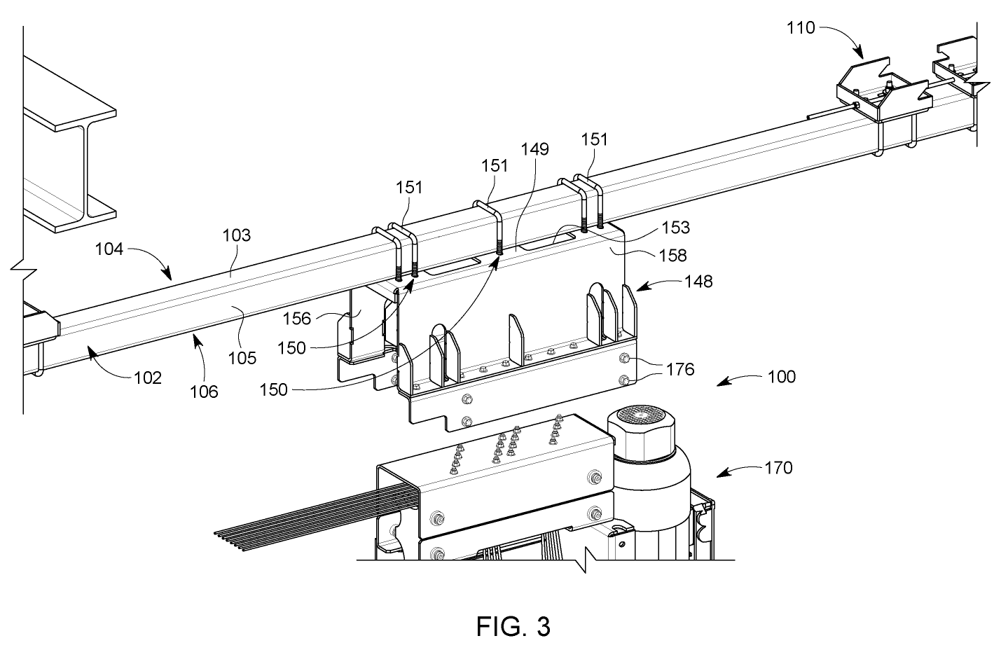

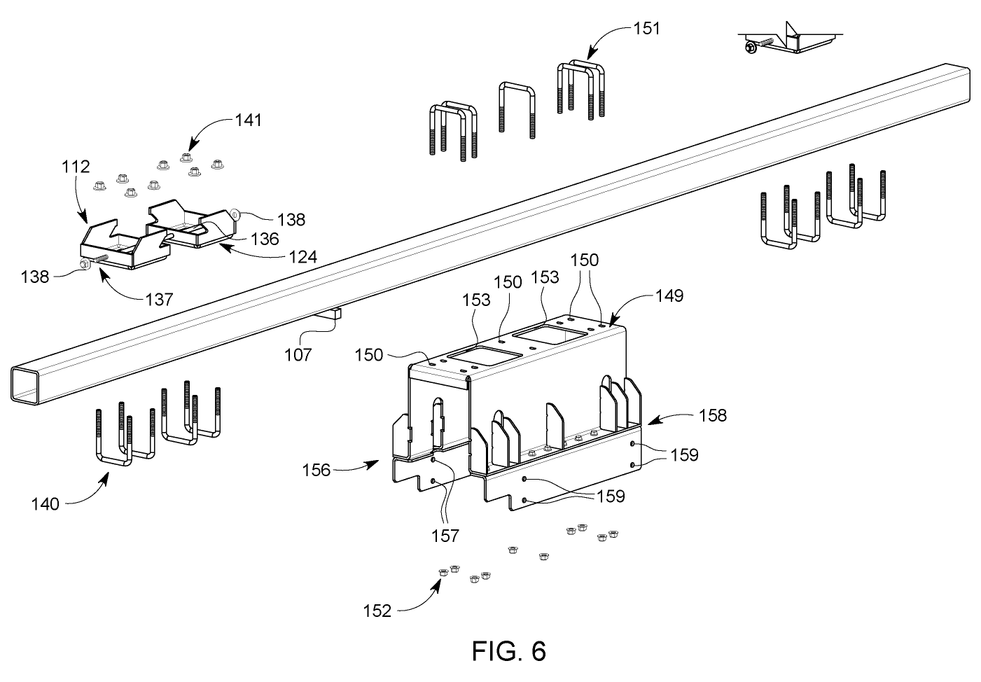

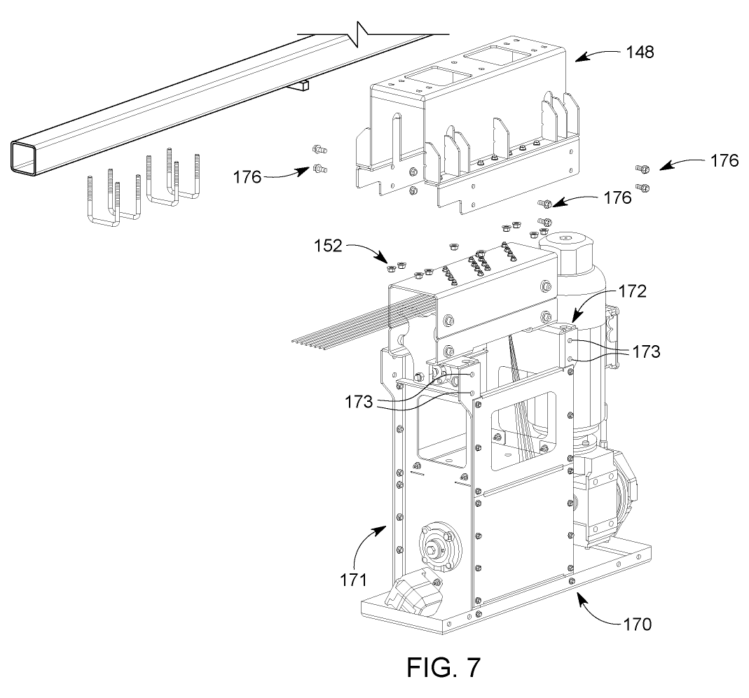

The mounting bracket 148 is best illustrated in FIGS. 3 and 6. Preferably, the mounting bracket 148 is generally an upside down U-shape and includes a top 149 from which a first side 156 and a second side 158 extend downward from opposing sides and form a receiving cavity therebetween in which a hoist assembly 170 is positioned. The top 149 includes apertures 150 configured and arranged to receive ends of U-bolts 151, which are positioned partially about the elongate member 102, for example about three sides, and nuts 152 secure the U-bolts 151 to the top 149. Optionally, the top 149 can include a friction pad 153, which can be made of rubber or another suitable material, configured and arranged to contact the elongate member 102 and prevent slipping when the U-bolts 151 are sufficiently tightened. The first side 156 includes apertures 157 and the second side 158 includes apertures 159. The apertures 157 and 159 align with bores 173 in a hoist connector 172 of the hoist assembly's frame 171, and fasteners 176 extend through the apertures 157 and 159 and into the bores 173 to connect the mounting bracket 148 to the hoist assembly 170. An example of how the hoist assembly 170 can connect to the mounting bracket 148 is best illustrated in FIG. 7.

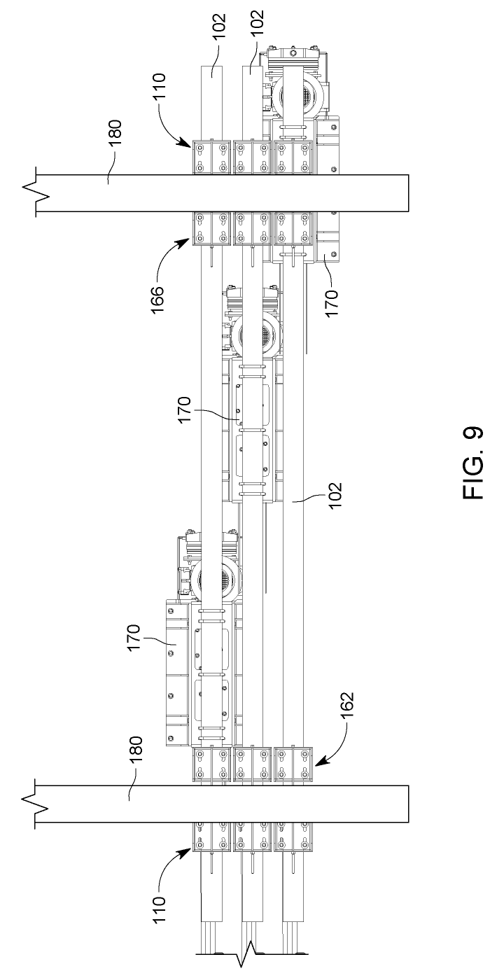

One or both of the beam clamp assembly 110 and the mounting bracket 148 can be positioned in a slidable position and a secured position. In the slidable position, the respective fasteners (e.g., U-bolts and nuts, rods and nuts) are at least loosened, for example for relatively slight position modifications, and can be removed, for example for relocation on another building structure. For example, for the beam clamp assembly 110, the nuts 138 on the ends 137 of the rod 136 are threaded toward the ends 137 to allow the first and second side clamps 112 and 124 to be slid outward in the slidable position 162. The nuts 141 on the U-bolts 140 may also need to be loosened to facilitate sliding of the first and second side clamps 112 and 124. For example, for the mounting bracket 148, the nuts 152 on the U-bolts 151 are loosened to facilitate sliding of the mounting bracket 148 relative to the elongate member 102. In the secured position, the respective fasteners are tightened to prevent movement or sliding relative to the mounting structure (e.g., I-beam flange and/or elongate member). The beam clamp assembly 110 is shown in the slidable position 162 and the secured position 166 in FIG. 9.

To install the hoist mounting assembly 100, the beam clamp assembly 110 is connected to the elongate member 102, preferably so that the first and second side clamps 112 and 124 can be slid outward relative to one another to receive the building structure (e.g., I-beam flange) and then slid inward toward one another to engage the building structure at a desired location. The fasteners are then secured to prevent the first and second side clamps 112 and 124 from moving relative to the building structure and the elongate member 102. To position the beam clamp assembly 110 along the building structure, for example to slide the beam clamp assembly 110 into a different position on the building structure, only one or both of the nuts 138 on the rod 136 can be loosened. The mounting bracket 148 is then connected to the elongate member 102. The U-bolts 151 are positioned about the elongate member 102, the U-bolt ends are inserted through the apertures 150 in the top 149 of the mounting bracket 148, and the nuts 152 secure the U-bolts 151 to the mounting bracket 148. The hoist assembly 170 can then be connected to the mounting bracket 148. Although the hoist assembly 170 can be connected to the elongate member 102 before connecting the elongate member 102 to the building structure, its added weight may make it easier to connect after connecting the elongate member 102 to the building structure.

Once installed, the hoist mounting assembly 100 can be positioned as desired. For example, the elongate member 102 can be slid along the flanges 181 of the I-beams 180 by loosening the beam clamp assemblies 110. This can be accomplished by loosening the nuts 138 on the threaded ends 137 of the rods 136 and sliding the first and second side clamps 112 and 124 away from each other. To remove the beam clamp assemblies 110 from the flanges 181, the first and second side clamps 112 and 124 can be slid outward so that the flange 181 is no longer positioned in the receiving channel 144. The nuts 141 on the U-bolts 140 can also be loosened to facilitate sliding of the first and second side clamps 112 and 124. In another example, the hoist assembly 170 can be slid along the elongate member 102 by loosening the mounting bracket 148. This can be accomplished by loosening the nuts 152 on the U-bolts 151. If the friction pad 153 is used, additional clearance may be needed.

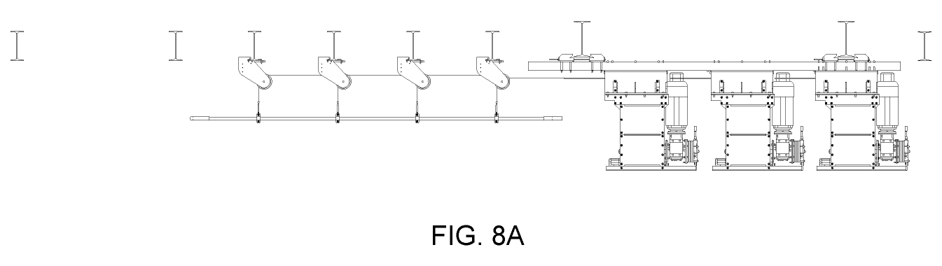

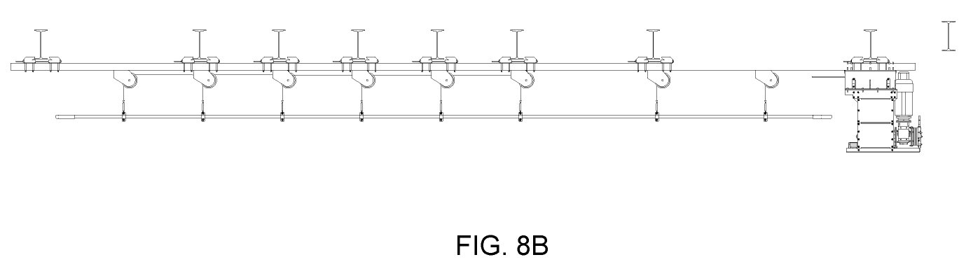

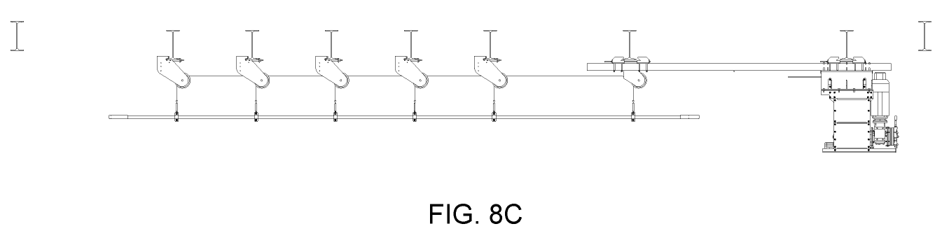

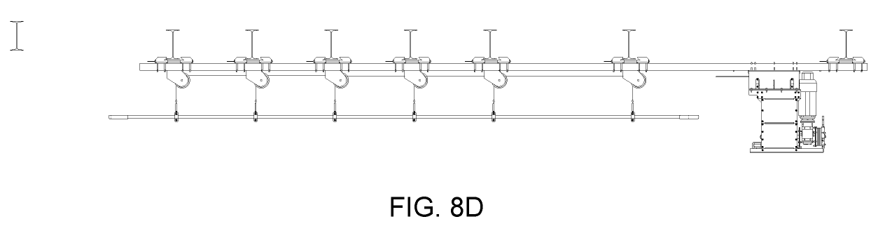

FIG. 8A illustrates an example first configuration rigging assembly, and FIG. 9 is a top view of the first configuration rigging assembly illustrated in FIG. 8A. In this configuration, three hoist assemblies 170 are each mounted to an I-beam 180 in a staggered, parallel arrangement. The elongate members 102 are positioned in parallel with spacing to accommodate the hoist assemblies 170. The beam clamp assemblies 110 on the left side are shown in unlocked configurations, and the beam clamp assemblies 110 on the right side are shown in locked configurations.

FIG. 8B illustrates an example second configuration rigging assembly. In this configuration, a loft block is positioned on the elongate member in a location best suited for the design that allows for longer battens when needed.

FIG. 8C illustrates an example third configuration rigging assembly. In this configuration, a motor head is positioned under the I-beam, which is a common configuration.

FIG. 8D illustrates an example fourth configuration rigging assembly. In this configuration, a motor head is positioned in a location best suited for the design.

The examples illustrated in FIGS. 8A-8D are not exhaustive and it is recognized that other suitable configurations can be used.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A hoist mounting assembly, comprising:an elongate member;a clamp assembly operatively connected to the elongate member and configured and arranged to selectively engage a portion of a building structure; anda mounting bracket operatively connected to the elongate member and configured and arranged to selectively engage a hoist assembly.

2. The hoist mounting assembly of claim 1, wherein the elongate member is a square tubular member made of metal.

3. The hoist mounting assembly of claim 1, wherein the clamp assembly is slidably operatively connected to the elongate member in a slidable clamp position and is secured to the elongate member in a secured clamp position.

4. The hoist mounting assembly of claim 1, wherein the mounting bracket is slidably operatively connected to the elongate member in a slidable mount position and is secured to the elongate member in a secured mount position.

5. The hoist mounting assembly of claim 1, further comprising a hoist connector configured and arranged to interconnect the mounting bracket and the hoist assembly.

6. The hoist mounting assembly of claim 1, wherein the clamp assembly comprises:a first side clamp operatively connected to the elongate member, the first side clamp including a first notch;a second side clamp operatively connected to the elongate member, the second side clamp including a second notch, the first and second notches forming a receiving channel configured and arranged to receive a portion of a building structure; andwherein the first and second side clamps are slidably operatively connected to the elongate member in a slidable clamp position and are secured to the elongate member in a secured clamp position.

7. The hoist mounting assembly of claim 6, further comprising a rod extending through the first and second side clamps, the rod configured and arranged to selectively limit movement of the first and second side clamps away from each other.

8. The hoist mounting assembly of claim 6, wherein the first side clamp includes a first base with first slots and the second side clamp includes a second base with second slots, further comprising first and second fasteners configured and arranged to extend through the respective first and second slots and interconnect the first and second side clamps and the elongate member.

9. A clamp assembly, comprising:an elongate member;a first side clamp operatively connected to the elongate member, the first side clamp including a first notch;a second side clamp operatively connected to the elongate member, the second side clamp including a second notch, the first and second notches forming a receiving channel configured and arranged to receive a portion of a building structure; andwherein the first and second side clamps are slidably operatively connected to the elongate member in a slidable clamp position and are secured to the elongate member in a secured clamp position.

10. The clamp assembly of claim 9, further comprising a rod extending through the first and second side clamps, the rod configured and arranged to selectively limit movement of the first and second side clamps away from each other.

11. The clamp assembly of claim 10, wherein the rod is positioned below the first and second notches.

12. The clamp assembly of claim 10, further comprising a fastener operatively connected to each rod end.

13. The clamp assembly of claim 9, wherein the first side clamp includes a first base with first slots and the second side clamp includes a second base with second slots, further comprising first and second fasteners configured and arranged to extend through the respective first and second slots and interconnect the first and second side clamps and the elongate member.

14. A mounting assembly, comprising:an elongate member;a mounting bracket operatively connected to the elongate member, wherein the mounting bracket is slidably operatively connected to the elongate member in a slidable mount position and is secured to the elongate member in a secured mount position; and 11 a hoist connector configured and arranged to interconnect the mounting bracket and a hoist assembly.

15. The mounting assembly of claim 14, further comprising a top of the mounting bracket including a friction pad configured and arranged to selectively engage the elongate member.

16. The mounting assembly of claim 14, further comprising:a top of the mounting bracket including apertures; andfasteners configured and arranged to extend through the apertures to interconnect the mounting bracket and the elongate member.

17. The mounting assembly of claim 16, wherein the fasteners are U-bolts configured and arranged to partially extend about the elongate member thereby positioning the elongate member between a top portion of the U-bolts and the top of the mounting bracket.

18. The mounting assembly of claim 17, wherein the U-bolts extend about three sides of the elongate member.

19. The mounting assembly of claim 14, wherein the mounting bracket forms a receiving cavity configured and arranged to receive the hoist connector and fasteners interconnect the mounting bracket and the hoist connector.
